(19) United States
(12) Patent Application Publication
(10) Pub. No.: US 2018/0200749 A1
(43) Pub. Date: Jul. 19, 2018

(54) JETTING DISPENSING SYSTEM INCLUDING FEED BY PROGRESSIVE CAVITY PUMP AND ASSOCIATED METHODS

(71) Applicant: NORDSON CORPORATION, Westlake, OH (US)

(72) Inventors: Cutler CROWELL, III, San Marcos, CA (US); Alan R. LEWIS, Carlsbad, CA (US)

(21) Appl. No.: 15/743,659

(22) PCT Filed: Aug. 2, 2016
(86) PCT No.: PCT/US2016/045087

§ 371 Date: Jan. 10, 2018

Related U.S. Application Data
(60) Provisional application No. 62/201,224, filed on Aug. 5, 2015.

(51) Int. Cl. B05C 11/10; F04C 14/00; F04C 2/107; B05D 1/02; B05C 5/02

(52) U.S. Cl. CPC B05C 11/1013; F04C 14/00; F04C 2270/185; B05D 1/02; B05C 5/0225; F04C 2/107

(57) ABSTRACT

A jetting dispensing system includes a dispenser body with a fluid chamber and a valve element, and a progressive cavity pump for feeding fluid into the fluid chamber. The progressive cavity pump propagates a plurality of separated cavities of fluid along an elongate length thereof to generate and maintain an incoming fluid pressure at a fluid inlet and the fluid chamber of the dispenser body. Accordingly, the droplets that are generated from operating the valve element in jetting dispensing cycles may define a volume of fluid, regardless of variations in fluid viscosity and variations in operational speed of the jetting dispensing system. Furthermore, the velocity profile of fluid exiting the dispenser body may be more constant to avoid causing changes in fluid velocity that can damage fluid particles and/or cause rotational tumbling or blossoming of the droplet while in flight towards the substrate.

### CROSS-REFERENCE TO RELATED APPLICATIONS

This application claims priority to provisional U.S. Patent App. No. 62/201,224, filed Aug. 5, 2015, which is incorporated herein by reference in its entirety.

### TECHNICAL FIELD

This application relates generally to fluid material dispensing systems and methods, and more specifically, to jetting systems for forming droplets onto a substrate.

### BACKGROUND

Jetting systems are well known in the dispensing arts for applying minute amounts of a fluid material onto a substrate. To this end, a “jetting system” is a device which ejects, or “jets”, a droplet of material from the dispenser to land on a substrate, wherein the droplet disengages from the dispenser nozzle with sufficient velocity to break away under it's own momentum. Thus, in a jetting type dispenser, the droplet does not rely on surface tension from the substrate to pull the material away from the nozzle. Additionally, a jetting system generates a formation of predictable droplets by pressurizing fluid with reciprocal movement of a valve element and forcing that fluid from the dispenser. To this end, the movement of the valve element generates a significant portion of the force (a high-pressure short-duration burst) required to push a volume of fluid from the dispenser and break it off from the dispenser as a droplet.

In a non-contact implementation of a jetting dispenser, the droplet of material disengages from the dispenser nozzle before making contact with the substrate. Thus, in a non-contact jetting dispenser, the droplet dispensed is “in-flight” between the dispenser and the substrate, and not in contact with either the dispenser or the substrate, for at least a part of the distance between the dispenser and the substrate. Although in some uses of a non-contact jetting dispenser, the dispenser may be positioned in close proximity to the substrate, which may cause the dispensed droplet to remain momentarily in contact with the substrate and the dispenser. In other types of jetting dispensers, a stream of material is produced from the dispenser such that the stream of material remains in contact with both the dispenser and the substrate during at least part of a dispensing operation.

Especially within the electronics assembly industry, numerous applications exist for jetting systems that dispense underfill materials, encapsulation materials, surface mount adhesives, solder pastes, conductive adhesives, solder mask materials, fluxes, and thermal compounds. As the type of application for the jetting system changes, the type of jetting system must also adapt to match the application change. One type of jetting system includes a valve element in the form of a needle with a tip configured to selectively engage a valve seat. During a jetting operation, the needle of the jetting system is moved relative to the valve seat by a driving mechanism, also referred to as a valve actuator. Contact between the tip of the needle and the valve seat seals off a discharge passage from a fluid chamber supplied with fluid material under pressure. Thus, to dispense droplets of the fluid material, the valve element is retracted from contact with the valve seat to allow a finite amount of the fluid material to flow through the newly formed gap and into the discharge passage. The tip of the needle is then moved rapidly toward the valve seat to close the gap, which generates pressure that accelerates the finite amount of fluid material through the discharge passage and causes a droplet of the material to be ejected, or jetted, from an outlet of the discharge passage.

Jetting systems are configured for controlled movements above the substrate and the fluid material is jetted to land on an intended application area of a substrate. By rapidly jetting the material continuously and “on the fly” (i.e., while the jetting system is in motion), the dispensed droplets may be joined to form a continuous line. Jetting systems may therefore be easily programmed to dispense a desired pattern of fluid material. This versatility has made jetting systems suitable for a wide variety of applications in the electronics industry. For example, underfill material can be applied using a jetting system to dispense fluid material proximate to one or more edges of the chip, with the material then flowing under the chip by capillary action.

As the movement of the dispenser and the reciprocal motion or speed of the valve element are both carefully programmed to produce a desired pattern on the substrate, it is desirable for each droplet dispensed during a cycle of the dispenser to be consistent and predictable in volume. To this end, variations in volume per droplet dispensed can adversely affect the pattern of fluid formed. In conventional jetting systems, pneumatic syringes are typically used as a feed system for supplying the fluid into the jetting dispenser. One example of such a syringe-based feed system is shown in U.S. Pat. No. 5,747,102, which is assigned to the Applicant listed on this application. However, such pneumatic-based systems typically only pressurize the incoming fluid up to about 6 to 7 barg (bar gauge) (approx. 87.02 psig (pounds per square inch gauge) to 101.53 psig), limited by typical industrial compressed air systems and safety requirements concerning compressed gas, and the pressure tends to vary at least a small amount depending on the amount of fill in the syringe. This relatively low pressure applied to the fluid and the variations that can occur lead to small variations in volumes of the droplets jetted by the jetting system, particularly between the beginning and the end of a syringe feed cycle. Such variations in droplet size are undesirable for the reasons described above.

The generally low pressure that can be provided to the fluid by a syringe-based feed system also has additional drawbacks. In this regard, FIG. 7 illustrates a schematic graphical plot of fluid displacement (relative to a valve seat or dispensing outlet of the jetting system) over time for the conventional jetting system described above, specifically over a single jetting dispensing cycle. Thus, points A and E on the plot are times where the valve tip is engaged with the valve seat, e.g., immediately before the valve tip is withdrawn by moving the valve element upwardly off the valve seat, and immediately after the valve tip has been advanced back into engagement with the valve seat. The fluid experiences a temporary snuff-back effect and moves away from the valve seat as a result of the valve tip withdrawal between points A and B, which is illustrated by the fluid displacement line moving below the horizontal zero axis. Between points B and D, the valve element is temporarily held in the open position by the valve actuator, and the pressurization applied by the syringe causes fluid to flow back to the valve seat and through the valve seat, which starts extrusion of a droplet from the dispenser at point C. The slope of the fluid displacement line is generally constant over this time window. The valve tip is advanced back into engagement with the valve seat over the time period from points D to E, and as shown in FIG. 7, this pressure spike causes a significant increase in fluid velocity as the final portion of the fluid exits the dispenser through the valve seat and/or outlet.

The non-linear velocity profile shown by this plot of FIG. 7 is typical in conventional syringe-based feed jetting systems, and the significant slope or velocity differences between points C (where fluid begins to exit the dispenser) and E (where the droplet breaks away from the dispenser) means that the last fluid to exit the dispenser is at a much higher velocity than the first fluid to exit the dispenser. Accordingly, the last material hits the slower moving fluid and causes a blossoming or rotational tumbling of the droplet. That type of tumbling or movement of the droplet can make the droplet difficult to control in flight so as to be applied as a predictable droplet on the substrate. The significant pressure spike causing this change in velocity also tends to be harsh on the fluid being dispensed, meaning some of the fluid in the droplet can be structurally damaged. Both of these results are undesirable, but largely unavoidable in the conventional jetting systems.

Syringe-based feed systems in conventional jetting systems are also sensitive to variations in fluid viscosity, which increases the complexity of programming the control of the jetting system to try and produce consistent droplets. In an effort to address some of these issues, the feed system of one type of jetting system was modified to include dual alternating positive displacement pumps in U.S. Patent Publication No. 2013/0048759, which is assigned to the Applicant listed on this application and the disclosure of which is incorporated by reference in its entirety herein. The alternating pumps in such an arrangement allow for one pump chamber to be refilled by a fluid source while the other chamber is pumped as a supply into the jetting dispenser. This cyclic refilling of chambers and the switching over from one pump chamber to the other as a supplying source of fluid potentially leads to certain adverse effects like a “wink” effect when switching between the two pumps, e.g., a discontinuity in the pressure or volume of the fluid supply into the jetting dispenser. As understood from the discussion of syringe-based systems above, such minor variations can lead to inconsistent pressurization in the jetting system and inconsistent volumes in the final jetted droplets released from the jetting system.

While conventional jetting systems have proven adequate for their intended purpose, improved jetting systems are desired that address the need for more consistent volume and controllable flight in each jetted droplet, while introducing additional degrees of flexibility to enable the jetting systems to be relatively easily configured for a variety of jetting applications, including those using fluids having varying viscosities.

### SUMMARY

According to one embodiment, a jetting system is provided for dispensing droplets of fluid onto a substrate. The jetting system includes a jetting dispenser body with a fluid chamber, a fluid inlet and a dispensing outlet communicating with the fluid chamber. A valve seat is defined in the fluid chamber between the fluid inlet and the dispensing outlet. The jetting system also includes a valve element extending into the fluid chamber and a valve actuator operatively coupled with the valve element for moving the valve element into and out of engagement with the valve seat, thereby defining jetting dispensing cycles for forcing droplets out of the dispensing outlet. A fluid supply assembly is coupled with the jetting dispenser body and includes a progressive cavity pump which feeds fluid from a fluid source to the fluid inlet of the jetting dispenser body. This arrangement may result in consistent volume droplets being discharged during the jetting dispensing cycles.

In one exemplary operation, the progressive cavity pump provides fluid into the jetting dispenser body at an incoming fluid pressure. Accordingly, the pressure within the fluid chamber is also maintained so as to be consistent, which may help result in consistent volume droplets of fluid being released from the system during the jetting dispensing cycles. Moreover, the progressive cavity pump operates to refill the fluid chamber with an equivalent volume of fluid that is removed during each of the jetting dispensing cycles. While a typical industrial compressed air supply is limited to 7 barg (approx. 101.53 psig), progressive cavity pumps are capable of producing fluid feed pressures up to 30 barg (approx. 435.11 psig) at the outlet of the pump while requiring only low pressure at the feed. This eliminates the need for high pressure pneumatic systems in dispensing applications requiring a high pressure fluid feed.

In one aspect, the progressive cavity pump of the jetting system further includes a pump housing and a central drive member. The pump housing defines a conduit along an elongate length thereof, the conduit including a contoured periphery. The central drive member extends through the conduit to define a plurality of separated cavities defined between the central drive member and the contoured periphery. Rotations of the central drive member cause propagation of the plurality of separated cavities along the elongate length of the conduit and towards the fluid inlet such that displacement forces on the fluid in each of the plurality of separated cavities are applied along an entirety of the elongate length of the conduit. To this end, the progressive cavity pump operates continuously when the jetting system is operating continuously “on the fly” to maintain the incoming fluid pressure at all times within the fluid chamber of the jetting dispenser body. As outlined above, the valve actuator controls the jetting dispensing cycles such that the incoming fluid pressure may result in droplets being released that have a consistent volume for each jetting dispensing cycle.

In another aspect, the jetting system includes a pressure sensor for confirming that the pressure is being delivered and maintained at the jetting dispenser body. For example, the system can further include a diaphragm located at the jetting dispenser body in communication with a flow path between the fluid inlet and the fluid chamber. The diaphragm receives the incoming fluid pressure. A load sensor coupled with the diaphragm measures the force based upon the pressure transferred to the diaphragm by the fluid, thereby to confirm that the incoming fluid pressure remains constant. The jetting system also includes a controller in such embodiments which adjusts actuations of the progressive cavity pump based on feedback from the pressure sensor (e.g., the load sensor), thereby to maintain the incoming fluid pressure. Alternatively or additionally, the controller may actuate the progressive cavity pump to rotate or move a set incremental amount for each actuation of the valve actuator.

In another aspect, the jetting system includes a controller which actuates the progressive cavity pump to supply fluid to the fluid inlet with the incoming fluid pressure being between 0.5 barg (approx. 7.25 psig) and 30 barg (approx. 435.11 psig) and, preferably, 1 to 2 bar (approx. 14.5 to 29.00 psig). Moreover, in some embodiments, the controller operates the valve actuator so that the valve element performs up to 500 jetting dispensing cycles per second. In other embodiments, the controller operates the valve actuator so that the valve element performs up to 3000 jetting dispensing cycles per second, particularly wherein the valve actuator comprises a piezoelectric element. The droplet size may remain consistent regardless of the speed of the jetting dispensing cycles, and also irrespective of variations in fluid viscosity thanks to the controlled fluid delivery of the progressive cavity pump.

In accordance with another embodiment described herein, a method is provided for dispensing a plurality of droplets of fluid onto a substrate. The method includes pumping fluid with a progressive cavity pump from a fluid source to a fluid inlet of a jetting dispenser body such that the fluid enters the jetting dispenser body. The fluid flows from the fluid inlet into a fluid chamber of the jetting dispenser body, the fluid chamber also communicating with a dispensing outlet and defining a valve seat between the inlet and the outlet. The method further includes operating a valve element extending into the fluid chamber with a valve actuator to move away from and towards engagement with the valve seat, thereby defining jetting dispensing cycles for forcing droplets out of the dispensing outlet for flight towards and onto the substrate. The pumping of fluid into the jetting dispenser body with the progressive cavity pump and the jetting dispensing cycles may collectively result in discharge of droplets having a consistent volume for each dispensing cycle.

The method may include one or more additional features as well. For example, the method also includes discharging droplets having a consistent volume for each jetting dispensing cycle regardless of changes in viscosity of the fluid. The operation of the valve element causes movement of the fluid relative to the valve seat over time, thereby defining a fluid velocity profile over time. The fluid velocity profile is generally constant such that the velocity of fluid that first exits the dispensing outlet in any given droplet is proximate to the velocity of fluid that last exits the dispensing outlet in that droplet. In this regard, the velocity of fluid exiting the dispensing outlet is controlled over time so as to avoid blossoming or rotational tumbling movements of the droplet during flight to the substrate.

The fluid velocity profile is generally constant as a result of the high pressure of the fluid within the fluid chamber. Accordingly, even though operation of the valve element typically causes a pressure spike when closing the valve element into engagement with the valve seat, an incoming fluid pressure maintained by the progressive cavity pump is sufficiently high to minimize this pressure spike in the fluid chamber. That minimized pressure spike results in minimized damage done to the particles of fluid that would otherwise be caused by pressure spikes. These benefits can be achieved by operating the progressive cavity pump to produce an incoming fluid pressure of at least 7 barg, for example.

As noted in detail above, the method may include actuating the valve element to perform up to 500 jetting dispensing cycles per second. In other embodiments, the valve element may be actuated to perform up to 3000 jetting dispensing cycles per second, particularly in an embodiment in which the valve element is actuated via a piezoelectric actuator. The progressive cavity pump once again includes a central drive member that is rotated continuously relative to a pump housing when the jetting system operates continuously “on the fly” to propagate separated cavities towards the fluid inlet and maintain the incoming fluid pressure at all times. This pressure may be sensed by a load sensor or some other type of pressure sensor to confirm that the incoming fluid pressure remains constant in various embodiments and adjust the operation of the progressive cavity pump accordingly. Of course, the progressive cavity pump may also be moved or rotated a set incremental amount for each actuation of the valve actuator in other embodiments.

These and other objects and advantages of the disclosure will become more readily apparent during the following detailed description taken in conjunction with the drawings herein.

### BRIEF DESCRIPTION OF THE DRAWINGS

FIG. 1 is a schematic view of a jetting system in accordance with various embodiments of the disclosure, the jetting system being fed by a progressive cavity pump.

FIG. 2 is a perspective view of the jetting system in accordance with one embodiment, the jetting system including an outer housing encasing the valve actuator and much of the jetting dispenser body, and a progressive cavity pump feeding the jetting dispenser body.

FIG. 2A is a perspective view similar to FIG. 2 and in which the outer housing of the jetting system has been removed to reveal several interior components in further detail.

FIG. 3 is a cross-sectional view of the jetting system of FIG. 2A, taken specifically along line 3-3 in FIG. 2A.

FIG. 3A is a view of a portion of a piezoelectric drive module which may be used as the valve actuator in the jetting system of FIG. 2.

FIG. 3B is a view of an alternative embodiment of the jetting system, particularly around the valve element, valve seat, and dispensing outlet thereof.

FIG. 3C is a view of yet another alternative embodiment of the jetting system, particularly around the valve element, valve seat, and dispensing outlet thereof.

FIG. 4 is an enlarged cross-sectional view of a portion of the jetting system as shown in FIG. 3.

FIG. 5 is a perspective view of the progressive cavity pump used with the jetting system of FIG. 2.

FIG. 6 is a cross-sectional view of the progressive cavity pump of FIG. 5, taken along line 6-6 in FIG. 5 to show the internal components thereof.

FIG. 7 is a schematic graphical plot of fluid displacement relative to the valve seat of a conventional jetting dispenser over time, and specifically over a single jetting dispensing cycle.

FIG. 8 is a schematic graphical plot of fluid displacement relative to the valve seat of the jetting system according to FIG. 1 over time, specifically over a single jetting dispensing cycle, for comparison purposes relative to the prior art shown in FIG. 7.

### DETAILED DESCRIPTION

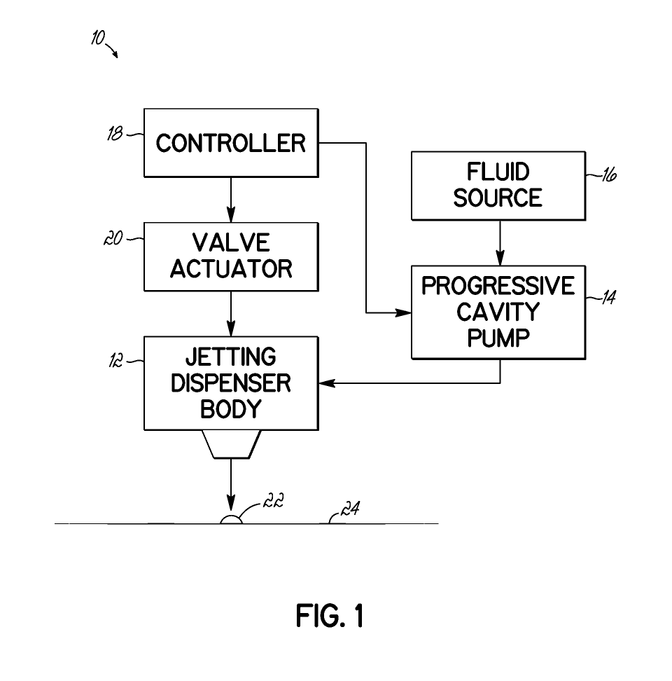

Several embodiments of a jetting dispensing system 10 are shown in FIGS. 1 through 6, the system 10 being capable of jetting/dispensing a plurality of droplets onto a substrate so that each droplet defines a consistent volume of fluid. In technical fields such as electronics assembly, this enables the jetted droplets to be more predictably applied in narrow grooves and spaces without spilling onto undesirable areas of the substrate. Furthermore, the jetting dispensing system 10 is configured to continue dispensing consistent volume droplets regardless of some operational parameter changes such as viscosity changes in the fluid being dispensed. In addition, the velocity profile of fluid exiting the jetting dispensing system 10 is maintained generally constant to avoid causing changes in fluid velocity that can damage fluid particles and/or cause rotational tumbling or blossoming of the droplet while in flight towards the substrate.

Beginning with reference to FIG. 1, a generalized schematic block diagram is shown of the jetting dispensing system 10 in accordance with embodiments of the disclosure. In this regard, the jetting dispensing system 10 includes a jetting dispenser body 12 with a fluid chamber (not shown in FIG. 1) and a valve element (not shown in FIG. 1), and a progressive cavity pump 14 for feeding fluid from a fluid source 16 into the fluid chamber of the jetting dispenser body 12. The progressive cavity pump 14 is actuated by a controller 18 of the jetting dispensing system 10, and this controller 18 is also configured to operate a valve actuator 20 that causes movement of the valve element within the jetting dispenser body 12 to produce jetting dispensing cycles for sending droplets 22 of fluid towards a substrate 24. The progressive cavity pump 14 propagates a plurality of separated cavities of fluid along an elongate length thereof to generate and maintain a consistent incoming fluid pressure at the jetting dispenser body 12. Accordingly, the droplets 22, which are generated from using the valve actuator 20 to operate the valve element in the jetting dispensing cycles, each define a consistent volume of fluid, regardless of variations in fluid viscosity and variations in operational speed of the jetting dispensing system 10.

As described in further detail below, different types of the jetting dispenser body 12 and valve actuator 20 may be used in various embodiments in accordance with this disclosure. Also, the controller 18 may include two separate controller or control elements for the progressive cavity pump 14 and the valve actuator 20 in other embodiments without departing from the scope of the disclosure. The several embodiments described in detail below are provided for exemplary purposes only, and the features thereof may be combined in any manner so long as the resulting system includes a progressive cavity pump 14 feeding a jetting dispenser body 12, thereby achieving the multiple functional benefits and advantages outlined throughout this disclosure.

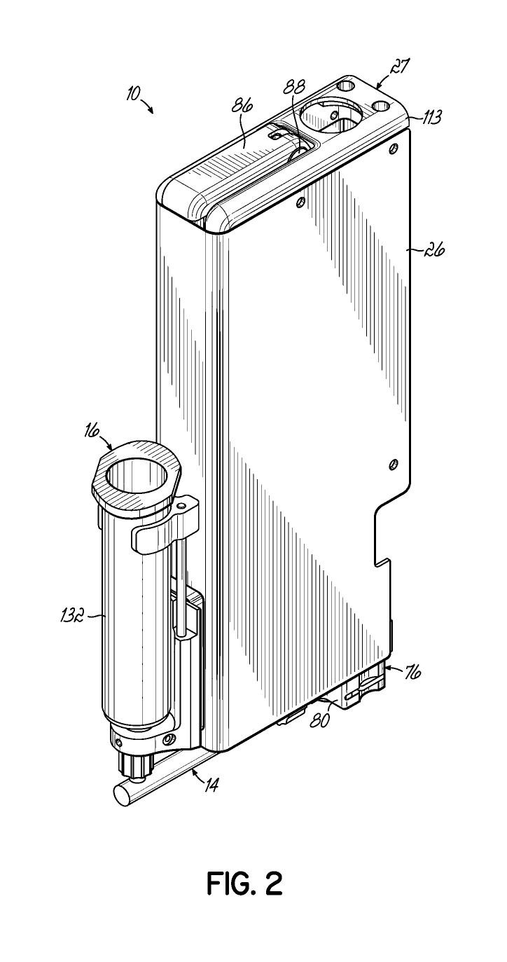

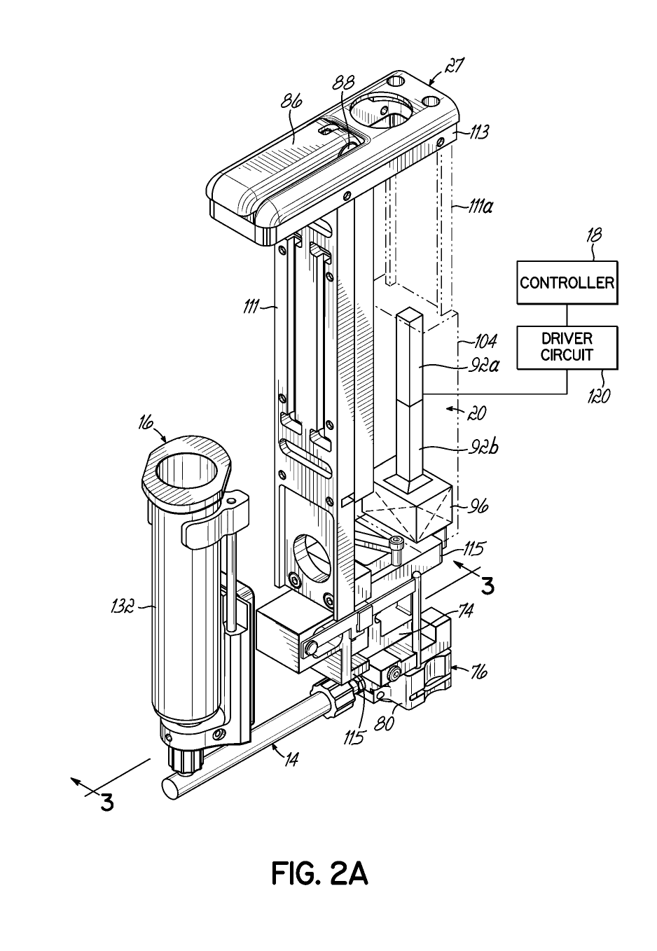

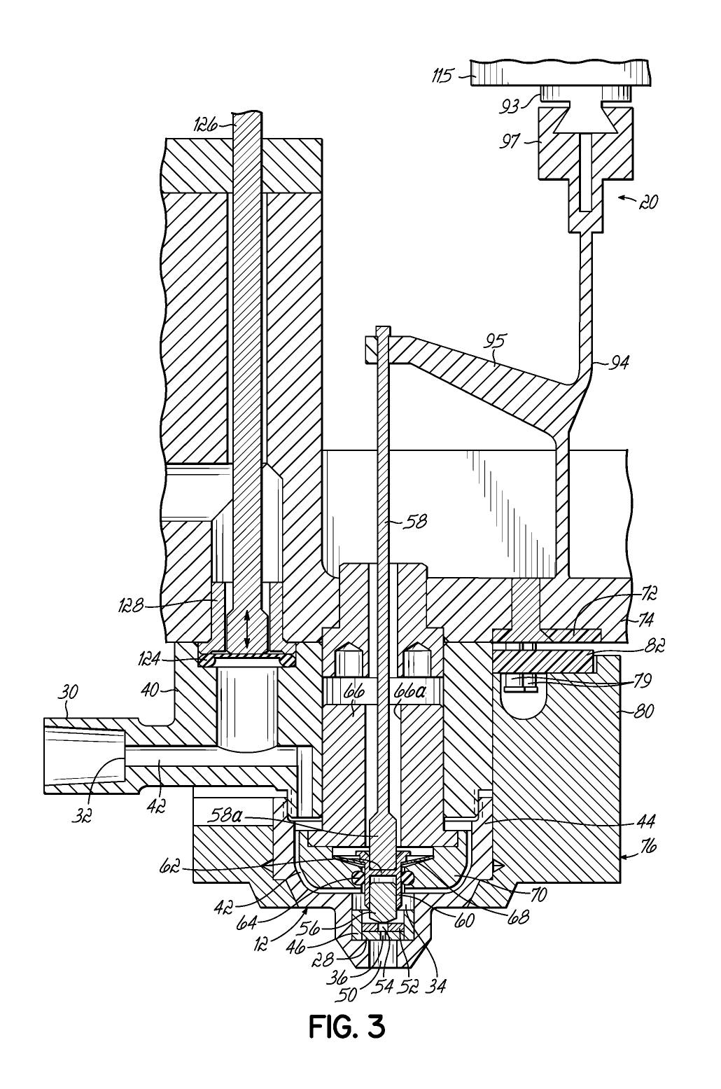

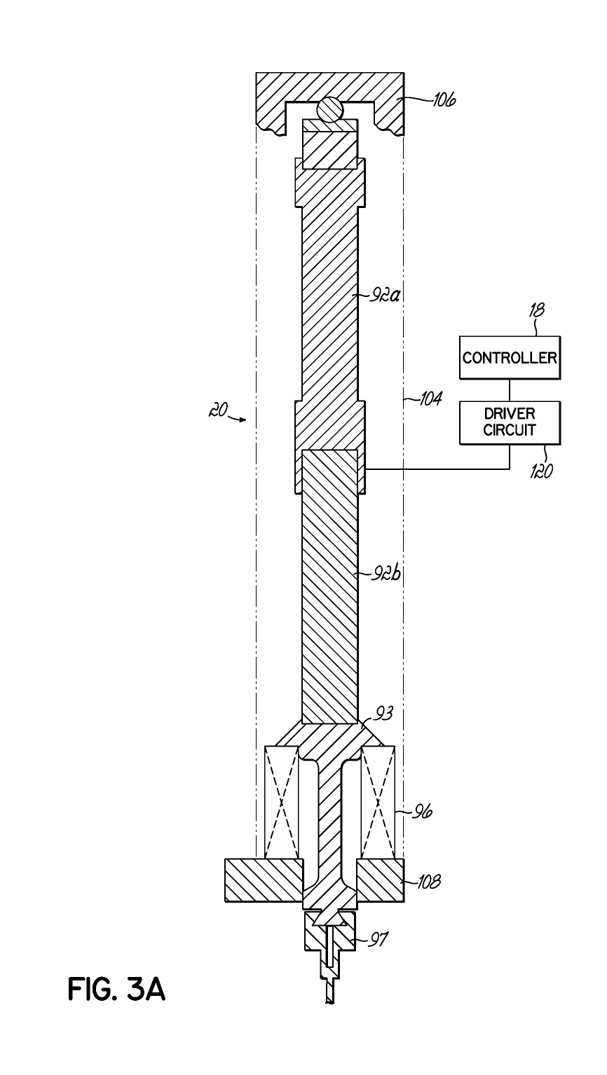

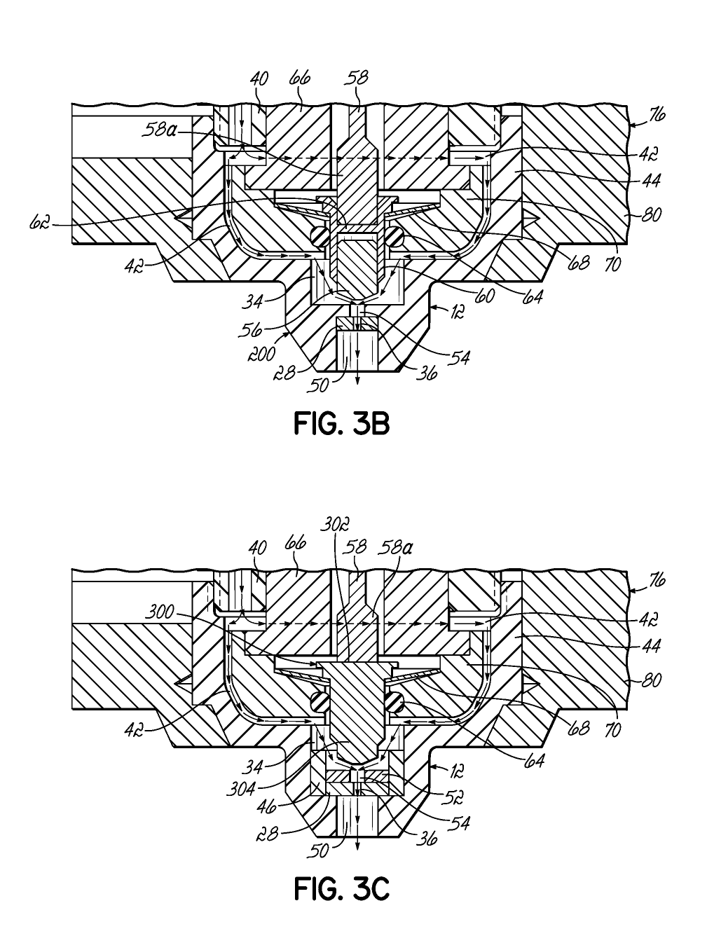

Turning to FIGS. 2, 2A, 3 and 3A, one exemplary embodiment of the jetting dispensing system 10 is shown in further detail. The jetting dispensing system 10 of this embodiment is a further development of the Intellijet® product line of jetting systems commercially available from Nordson Corporation, the Applicant of the present application. More specifically, this jetting dispensing system 10 contains many similar elements to the systems described in U.S. Patent Publication No. 2013/0048759 (referenced above), and consequently, the jetting dispensing system 10 achieves many of the same functional benefits set forth in that prior patent publication. However, the jetting dispensing system 10 now includes the progressive cavity pump 14 as briefly described above, which provides a number of additional functional benefits and advantages when jetting fluids, such as in the electronics assembly and manufacturing fields. The following description includes details regarding both the elements similar to the prior published application and the new elements, so as to provide a comprehensive picture of one embodiment of the disclosure set forth herein.

As shown in these Figures, the jetting dispensing system 10 includes a fluid module, the majority of which is contained within an outer cover 26, as well as valve actuator 20 in the form of a piezoelectric drive module, which is also substantially contained within the outer cover 26. The fluid module includes the jetting dispenser body 12 and other elements as set forth in detail below. The outer cover 26 is composed of thin sheet metal in this embodiment and is fastened to a primary support structure 27 of the jetting dispensing system 10 by conventional fasteners. As will be described in further detail below, the primary support structure 27 includes multiple elements serving as connection points for the various elements of the fluid module and the piezoelectric drive module, these multiple elements including at least a lower structural member 115, an upper structural member 113 and a support wall 111 that extends between and joins the upper and lower structural members 113, 115 (these elements being best shown in FIG. 2A). The jetting dispensing system 10 also includes a fluid supply assembly, which includes both the progressive cavity pump 14 and the fluid source 16 in this embodiment. Therefore, in the broadest sense, fluid from the fluid supply assembly is directed to the fluid module, and the piezoelectric drive module actuates elements of the fluid module to dispense the fluid as droplets 22 that fly towards a substrate 24.

With specific reference to FIG. 3, the fluid module is shown in further detail. In this regard, the fluid module includes a nozzle 28, the jetting dispenser body 12, and a fluid connection interface 30 which defines a fluid inlet 32 for the jetting dispenser body 12. The fluid connection interface 30 in this embodiment includes a Luer fitting which is configured to be connected to an outlet tubing or conduit extending from the progressive cavity pump 14. As such, the progressive cavity pump 14 and the fluid supply assembly as a whole can be quickly and easily disconnected from the fluid module when necessary. Other types of fluid connection interfaces may be used in other embodiments without departing from the scope of this disclosure.

A fluid chamber 34 is defined within the jetting dispenser body 12, so as to communicate between the fluid inlet 32 and a dispensing outlet 36 provided proximate the nozzle 28. A first section 40 of the jetting dispenser body 12 includes the fluid inlet 32 (at the fluid connection interface 30) and a passageway 42 defining a flow path that couples the fluid inlet 32 into communication with the fluid chamber 34. A second section 44 of the jetting dispenser body 12 is configured to support the nozzle 28. A centering piece 46 inserted into the second section 44 aligns a dispensing outlet 36 in the nozzle 28 with a central passageway 50 extending through the second section 44 of the jetting dispenser body 12. A valve seat 52 is positioned between the fluid inlet 32 and the dispensing outlet 36, and more specifically, between the bottom end of the fluid chamber 34 and the nozzle 28. The valve seat 52 has an opening 54 in fluid communication with the dispensing outlet 36. The centering piece 46 maintains the dispensing outlet 36 in the nozzle 28, the central passageway 50 in the second section 44 of the jetting dispenser body 12, and the opening 54 in the valve seat 52 in a generally co-axial alignment. More particularly, in the embodiment shown, the second section 44 includes a shoulder at a portion of the central passageway 50, this shoulder supporting each of the centering piece 46, the nozzle 28, and the valve seat 52 in the desired positions. These elements 44, 46, 52 and 28 are formed separately in this embodiment and therefore can be held in place in place relative to each other by an adhesive bond between the components.

Alternatively, some or all of these elements 44, 46, 52 and 28 can be made as a single unified/integral piece. As one example of such an alternative, FIG. 3B shows an embodiment where the second section 44, the centering piece 46 and the valve seat 52 are replaced by and made as a single unified piece 200, and the nozzle 28 is attached to the unified piece 200 adjacent the “valve seat” by, for example, adhesive or by a threaded connection. It will be appreciated that other alternative separate and integral formations may be used for the elements described in the fluid module.

Returning to the embodiment shown in FIG. 3, a valve element 56 is located within the fluid chamber 34 so as to be positioned for movement into and out of engagement with the valve seat 52. The valve element 56 is driven by the valve actuator 20 (e.g., the piezoelectric drive module) to perform reciprocal movements as described in further detail below. The valve element 56 is mounted in the fluid module in a movable element 60. The movable element 60 further defines a strike plate in the form of a transverse wall 62 bounded on upper and lower sides by receptacles. One of these receptacles receives the valve element 56, and the opposite receptacle receives a tip 58a of a movable needle or drive pin 58. To this end, the tip 58a of the drive pin 58 is located adjacent to the wall 62 of the movable element 60 and on an opposite side of the wall 62 from the valve element 56. As shown in these Figures, the drive pin 58 is the element that extends out of the fluid module for connection to the valve actuator 20.

The jetting dispenser body 12 further includes a third section 66 carrying an insert 70, these elements collectively facing towards the second section 44 of the jetting dispenser body 12 to define an opposite or top end of the fluid chamber 34. The third section 66 and insert 70 collectively define a bore 66a through which the drive pin 58 and the movable element 60 extend. A biasing element 68, such as a spring, is located between the movable element 60 and the insert 70, the biasing element 68 providing an axial force that biases the movable element 60 and the valve element 56 away from contact with valve seat 52.

A sealing ring 64 supplies a sealing engagement between the insert 70 and an exterior of the movable element 60. The sealing ring 64 may include an O-ring that flexes with movement of the movable element 60, or some other alternative seal like a dynamic seal that the movable element 60 would slide against. The part of the movable element 60 which is below the sealing ring 64 also defines a part of the boundary of the fluid chamber 34. The valve element 56 is attached to movable element 60 and is therefore located inside the fluid chamber 34 at a location between the wall 62 of the movable element 60 and the valve seat 52. The movable element 60 transfers movements of the drive pin 58 to movements of the valve element 56. Alternatively, the separate elements assembled together in this portion of the fluid module (the valve element 56 and the movable element 60) may be made as a single unified movable element, as shown in the alternative embodiment of FIG. 3C.

With reference to FIG. 3C, in embodiments where a unified movable element 300 is used, that element 300 would include an upper portion 302 facing the drive pin 58 and a lower end 304 facing the fluid chamber 34. The drive pin 58 would therefore contact the upper portion 302 of element 300 and selectively move it downwardly to cause the lower end 304 to contact the valve seat and jet a droplet of fluid. As indicated in FIG. 3C, in the same way as in the other disclosed embodiments, the outer surface of element 300 would be sealed against the sealing ring 64 and the biasing element 68 would provide a biasing force on the element 300. As such, the general operation does not change regardless of whether some of the elements are combined together in the unitary pieces 200, 300 shown in the alternative embodiments of FIGS. 3B and 3C, or other potential similar combinations and alternatives.

Returning to FIG. 3, the assembly of the parts of the fluid module is conducted as follows. The third section 66 of the jetting dispenser body 12 may be attached to the top of the insert 70 by a friction fit. The second section 44 of the jetting dispenser body 12 is then attached by a friction fit to the first section 40 of the jetting dispenser body 12 to enclose all the other components of the fluid module. For example, the insert 70 is larger in cross-sectional area than portions of the first and second sections 40, 44 located above and below the insert 70, so the friction fit engagement of the first and second sections 40, 44 of the jetting dispenser body 12 captures or sandwiches the insert 70 into position within the fluid module. The insert 70 in some embodiments may also be forced into a friction fit along a bottom side thereof with the second section 44 as well. Generally, the first section 40 and the second section 44 are pressed together to substantially enclose these parts of the fluid module: the nozzle 28, the valve seat 52, the centering piece 46, the valve element 56, the movable element 60, the sealing ring 64, the biasing element 68, the insert 70, and the third section 66 of the jetting dispenser body 12. Thus, in the preferred embodiment, the fluid module is comprised of each of these elements following the assembly of parts described above. While certain of the components of the fluid module have been described as being connected by friction fit, the friction fits between these components can be replaced by threads to permit the components to be disassembled and reassembled in different manners. Other connection methods between these parts may also fall within the scope of this disclosure.

In the assembled position described above and shown in FIG. 3, the passageway 42 that couples the fluid inlet 32 in fluid communication with the fluid chamber 34 is provided as follows. A first portion of the passageway 42 extends completely within the first section 40 of the jetting dispenser body 12. An annular portion of the passageway 42 communicates with this first portion, and it is created by a space provided between the first section 40 and the third section 66 of the jetting dispenser body 12. The passageway 42 then continues from this annular portion between the insert 70 and the second section 44 down to the fluid chamber 34. In embodiments where the insert 70 is friction fit inside the second section 44 during assembly of the fluid module, the insert 70 is provided with several grooves along an outer periphery thereof to define this final portion of the passageway 42. Alternatives may be provided as well, such as drilling a hole through the insert 70 (this would suffice if the insert 70 in an alternative embodiment were threadably connected with the second section 44). Accordingly, when the jetting dispenser body 12 is fully assembled, a path for fluid flow is defined from the fluid inlet 32 at the fluid connection interface 30, through the passageway 42 to the fluid chamber 34, and then through the opening 54 of the valve seat 52 to the dispensing outlet 36.

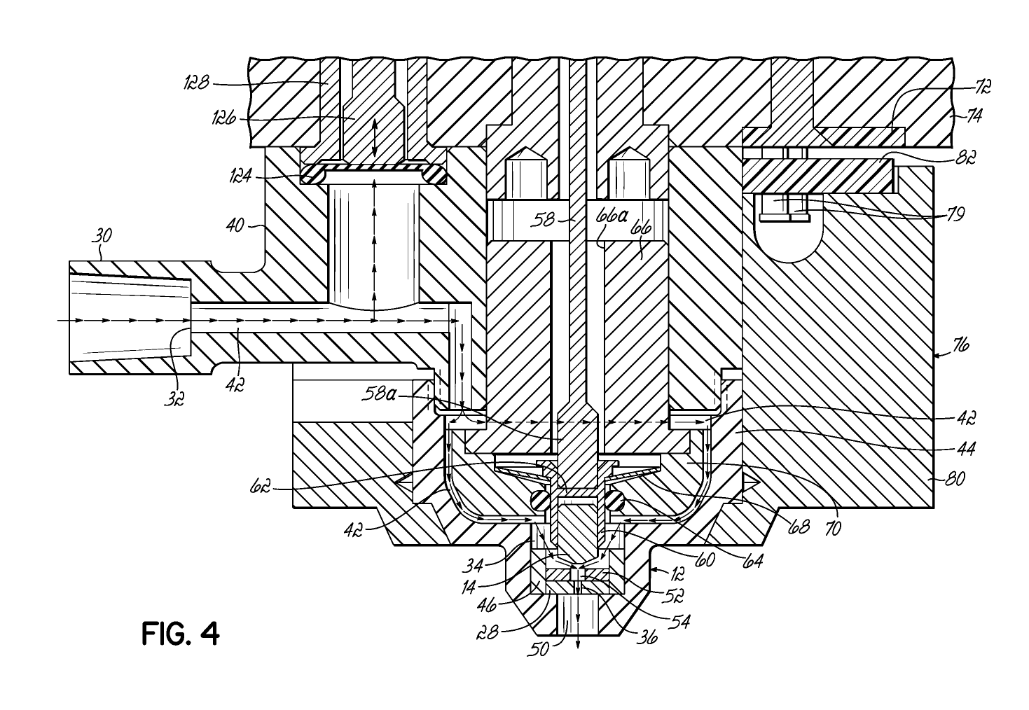

The operation of the valve components in the wetted portion of the fluid module shown in FIG. 3 will now be summarized. The drive pin 58 is indirectly coupled with the valve element 56 via the movable element 60 and operates as a component of the piezoelectric drive module. The drive pin 58 and the valve element 56 jointly cooperate to dispense fluid material by jetting from the jetting dispensing system 10. When the drive pin 58 is moved to cause the valve element 56 to contact the valve seat 52, the tip 58a of the drive pin 58 operates much like the operation of a hammer by striking the wall 62 of the movable element 60 to transfer its force and momentum to the wall 62, which in turn causes the valve element 56 to rapidly strike the valve seat 52 and jet a droplet of material from the jetting system. Specifically, the valve element 56, which is not directly connected with the drive pin 58, is configured to be moved into contact with the valve seat 52 by an impulse imparted by the tip 58a of the actuated drive pin 58 to the wall 62 of the movable element 60. As a result, the drive pin 58 is actuated and an amount of fluid material is jetted from the fluid chamber 34 without any portion of the drive pin 58, including but not limited to the tip 58a, being wetted by the fluid material. When contact between the drive pin 58 and the wall 62 is removed, the axial force applied by the biasing element 68 acts to move the valve element 56 and the movable element 60 away from the valve seat 52 in a direction aligned with the longitudinal axis of the drive pin 58. Each reciprocating cycle of the drive pin 58 and the valve element 56 therefore jets a droplet of the fluid material. The cycle is repeated to jet sequential droplets of fluid material as required. Furthermore, in some embodiments, the valve actuator 20 is configured to enable these jetting dispensing cycles to be repeated up to 500 times per second. In other embodiments, particularly those in which the valve actuator 20 comprises a piezoelectric actuator, the valve actuator 20 is configured to provide up to 3000 jetting dispensing cycles per second. The flow of fluid when the valve is open is shown more clearly by the flow arrows in FIG. 4, which is an expanded larger view of the fluid module shown in FIG. 3 and described in detail above.

The surface of the valve element 56 facing the valve seat 52 may have a curvature to match the curvature or shape of the surface of the valve seat 52 encircling opening 54. As a result of the shape matching, a fluid seal is temporarily formed when the valve element 56 has a contacting relationship with the valve seat 52 during jetting. Establishment of the fluid seal during motion of the valve element 56 halts the flow of fluid material from the fluid chamber 34 past the valve seat 52, and the impact of these elements tends to apply force or pressure that breaks the fluid droplet away from the dispensing outlet 36.

While the valve element 56 is exposed to the fluid material contained inside the fluid chamber 34, the bore 66a containing the drive pin 58 is isolated from the fluid material in the fluid chamber 34 (e.g., by the sealing ring 64) so that the drive pin 58 is not wetted by the fluid material. As a result, the construction of the jetting dispensing system 10 can omit the conventional fluid seals that permit powered motion of the drive pin 58 while isolating the driving or actuation mechanism (e.g., piezoelectric drive module) for the drive pin 58 from the fluid material in the fluid chamber 34. That simplifies the assembly and operation of the jetting dispensing system 10.

One of the fluids that can be jetted using the jetting dispensing system 10 is adhesive, which typically needs to remain heated during the jetting process. Consequently, a heater 76 is provided in this embodiment as shown in FIGS. 2, 2A and 3 with a body 80 that operates as a heat transfer member, the heater 76 at least partially surrounding the fluid module. The heater 76 may include a conventional heating element (not shown), such as a cartridge-style resistance heating element residing in a bore defined within the body 80. The heater 76 may also be equipped with a conventional temperature sensor (not shown), such as a resistive thermal device (RTD), a thermistor, or a thermocouple, providing a feedback signal for use by a temperature controller (which may be the controller 18) in regulating the power supplied to the heater 76. The heater 76 includes pins 79 that contact respective soft, electrically conductive contacts 72 associated with an actuator body 74 (described below) in order to provide signal paths for a temperature sensor and to provide current paths for transferring electrical power to the heater 76 and temperature sensor. At least part of the fluid module, including the second section 44 of the jetting dispenser body 12 and the insert 70, sits within the heater 76, and when the heater 76 is drawn against the actuator body 74 by retainer arms, the fluid module is effectively held in position by compression between the heater 76 and the actuator body 74.

With reference to FIGS. 2 through 3A, in one embodiment, the piezoelectric drive module, also referred to as the valve actuator 20, is used to actuate the valve element 56 of the fluid module. Piezoelectric drivers for dispensing valves are known, and one exemplary driver or drive module is described in further detail below. Before describing those details, the valve actuator 20 includes the actuator body 74 as shown in FIGS. 2A and 3. The actuator body 74 mates with and sits directly above the fluid module and heater 76. To this end, the actuator body 74 may be positioned into contact with upper ends of the first and third sections 40, 66 of the jetting dispenser body 12. The actuator body 74 would also be brought into contact with the heater 76, but the heater body 80 is designed with either an insulating block 82 located between these elements or a gap is left as shown in FIG. 3. This focuses the heat transfer from the heater 76 into the fluid module instead of the actuator body 74, which is advantageous because that is where the fluid needing heat energy is located. On the opposite side of the fluid module, the actuator body 74 is mounted to the lower structural member 115 of the support wall 111 (at least one rod-like connection is shown between these elements at FIG. 2A, for example). Thus, the actuator body 74, once it is engaged with the fluid module, provides structural support for other elements of the valve actuator 20 as well as the fluid module.

Although not shown in detail in the Figures of this application, the fluid module may be configured for quick connection and disconnection from the actuator body 74 and the support wall 111. To this end, a draw bar (not shown) may be engaged with the jetting dispenser body 12, the draw bar connected via a rod or some other structure to a release lever 86 which is located adjacent the upper structural member 113 as shown in FIGS. 2 and 2A. The release lever 86 rotates about a pivot axis 88 to cause cam movements which pull the draw bar upwardly towards the support wall 111 or push the draw bar downwardly. When the draw bar is pulled upwardly, such as by placing the release lever 86 in the position shown in the Figures, the fluid module including the jetting dispenser body 12 are drawn upwardly into contact with the actuator body 74 as described above. Thus, similar to that described in U.S. Patent Publication No. 2013/0048759, the fluid module and the heater 76 can be quickly and easily released and removed if desired.

The valve actuator 20 is embodied as a piezoelectric drive module and includes piezoelectric stacks 92a and 92b, a plunger 93, and an asymmetrical flexure 94. While two piezoelectric stacks 92a, 92b are provided in this embodiment, only one piezoelectric stack may be used or more than two stacks in other embodiments without departing from the scope of this disclosure. The flexure 94 is formed in this embodiment as an integral part of the actuator body 74 and includes a coupling element 97 along one side that connects the flexure 94 to the plunger 93 (the opposite side being connected integrally to the remainder of the actuator body 74). The flexure 94 is located largely offset from the drive pin 58, but the flexure 94 also includes an arm 95 between the opposite sides that extends laterally towards the drive pin 58 for purposes set forth in further detail below. A spring 96 applies a spring force to the plunger 93 and the piezoelectric stacks 92a, 92b to keep them in compression. These elements of the piezoelectric drive module are shown in FIGS. 2A and 3, in the exemplary embodiment, and the functionality and operation of these elements are described in further detail below.

With reference to FIG. 3A, additional details are shown regarding the valve actuator 20 and the surrounding support for the piezoelectric elements. In this regard, the piezoelectric stacks 92a, 92b, the plunger 93, and the spring 96 are confined as an assembly between mechanical constraints supplied by a C-shaped bracket 104 having upper and lower extensions 106, 108. The bracket 104, also shown in phantom in FIG. 2A, is supported between the lower structural member 115, and at least one elongated support member 111a that is attached to an upper structural member 113. More particularly, the upper extension 106 of the bracket 104 shown in FIG. 3A is connected to the elongated support member 111a to provide rigid support at the top of the piezoelectric stacks 92a, 92b. The lower extension 108 of the bracket 104 is coupled to or sits atop the lower structural member 115 to provide rigid support at the bottom of the piezoelectric stacks 92a, 92b, specifically at the spring 96. The plunger 93 has a lower portion that projects through the lower extension 108 of the bracket 104 and through the lower structural member 115 so that it can be coupled to the flexure 94 at the coupling element 97. At the opposite upper end portion, the plunger 93 has an enlarged shoulder which engages with an upper end of the spring 96. As the lower end of spring 96 rests atop the lower extension 108 of bracket 104, the spring 96 pushes the plunger 93 upwardly to maintain some compression on the piezoelectric stacks 92a, 92b at all times. The particular structural support and layout of actuator elements shown in FIG. 3A and the other Figures may be modified in other embodiments.

The plunger 93 functions as a mechanical interface connecting the piezoelectric stacks 92a, 92b with the asymmetrical flexure 94. The spring 96 is compressed in the assembly such that the spring force generated by the spring 96 applies a constant load on the piezoelectric stacks 92a, 92b, which preloads the piezoelectric stacks 92a, 92b. As shown most clearly in FIG. 3, the arm 95 of the asymmetrical flexure 94, which may be comprised of a metal, is physically secured with an end of the drive pin 58 opposite to the tip 58a of drive pin 58. The asymmetrical flexure 94 functions as a lever-like mechanical amplifier that converts the relatively small displacement of the piezoelectric stacks 92a, 92b into a larger, useful displacement for the drive pin 58 that is more significant than the original displacement of the piezoelectric stacks 92a, 92b.

The piezoelectric stacks 92a, 92b of the piezoelectric drive module are a laminate comprised of layers of a piezoelectric ceramic that alternate with layers of a conductor as is conventional in the art. The spring force from the spring 96 maintains the laminated layers of the piezoelectric stacks 92a, 92b in a steady state of compression. The conductors in the piezoelectric stacks 92a, 92b are electrically coupled with a driver circuit 120, which supplies current-limited output signals, in a manner well known in the art, with pulse width modulation, frequency modulation, or a combination thereof. When power is periodically supplied from the driver circuit 120, electric fields are established that change the dimensions of the piezoelectric ceramic layers in the piezoelectric stacks 92a, 92b.

The dimensional changes experienced by the piezoelectric stacks 92a, 92b, which are mechanically amplified by the asymmetrical flexure 94, move the drive pin 58 linearly in a direction parallel to its longitudinal axis. When the piezoelectric ceramic layers of the piezoelectric stacks 92a, 92b expand, the spring 96 is compressed by the force of the expansion and the asymmetrical flexure 94 pivots about a fixed pivot axis to cause movement of the tip 58a of the drive pin 58 upward in FIG. 3 away from the wall 62 of movable element 60. This allows the biasing element 68 to move the movable element 60 and the valve element 56 away from valve seat 52. When the actuation force is removed and the piezoelectric ceramic layers of the piezoelectric stacks 92a, 92b are permitted to contract, the spring 96 expands and the asymmetrical flexure 94 pivots to move the drive pin 58 downward in FIG. 2 so that the tip 58a moves into contact with the wall 62, causing the valve element 56 to contact the valve seat 52 and jet a droplet of material. Thus, in the de-energized state, the piezoelectric stack assembly maintains the valve in a normally closed position. In normal operation, the asymmetrical flexure 94 intermittently rocks in opposite directions about a fixed pivot axis as the piezoelectric stacks 92a, 92b are energized and de-energized to move the tip 58a of the drive pin 58 into and out of contact with the wall 62 of the movable element 60 to jet droplets of material at a rapid rate.

The driver circuit 98 for the valve actuator 20 is controlled by the controller 18, which as described above, may be the same controller 18 which actuates and operates the progressive cavity pump 14 as well. The controller 18 may comprise any electrical control apparatus configured to control one or more variables based upon one or more inputs. The controller 18 can be implemented using at least one processor selected from microprocessors, micro-controllers, microcomputers, digital signal processors, central processing units, field programmable gate arrays, programmable logic devices, state machines, logic circuits, analog circuits, digital circuits, and/or any other devices that manipulate signals (analog and/or digital) based on operational instructions that are stored in a memory. The memory may be a single memory device or a plurality of memory devices including but not limited to random access memory (RAM), volatile memory, non-volatile memory, static random access memory (SRAM), dynamic random access memory (DRAM), flash memory, cache memory, and/or any other device capable of storing digital information. The controller 18 may also include a mass storage device of various types, and also a human machine interface for interacting with a user.

The processor of the controller 18 operates under the control of an operating system, and executes or otherwise relies upon computer program code embodied in various computer software applications, components, programs, objects, modules, data structures, etc. The program code residing in memory and stored in the mass storage device also includes control algorithms that, when executing on the processor, control the operation of the valve actuator 20 and, in particular, provide control signals to the driver circuit 98 for driving the piezoelectric drive module. The computer program code typically comprises one or more instructions that are resident at various times in memory, and that, when read and executed by the processor, causes the controller 18 to perform the steps necessary to execute steps or elements embodying the various embodiments and aspects of the disclosure.

For example, the computer program code that is executed by the controller 18 may provide actuation signals to expand and contract the piezoelectric stacks 92a, 92b up to 500 times per second or up to 3000 times per second, which will result, respectively, in up to 500 or up to 3000 jetting dispensing cycles per second as well. However, it will be appreciated that the specific computer program code and operational functionality may be modified in other embodiments that remain consistent with this disclosure.

The controller 18 of this embodiment is also used to control the operation of additional devices supporting the operation of the jetting dispensing system 10. In this regard, the controller 18 is operatively coupled with a pressure sensor which is used measure the force or pressure of the fluid provided to the fluid chamber 34 and to control operation of the feed of fluid into the jetting dispenser body 12. More particularly, in one embodiment, the controller 18 communicates with a load cell (not shown) that generates pressure measurement readings through a connection with a diaphragm 124 by means of a rod 126, as described below. The diaphragm 124 is located to receive the consistent incoming fluid pressure applied by the progressive cavity pump 14 at the fluid inlet 32. Therefore, these pressure measurement readings are communicated to the controller 18 as feedback for use in a closed loop control of the operation of the progressive cavity pump 14 of jetting dispensing system 10. The controller 18 can be used to control and receive feedback from any number of elements within the jetting dispensing system 10. At a minimum, the controller 18 (or a plurality of control elements working together) actuates the piezoelectric drive module at valve actuator 20 and the feed device at progressive cavity pump 14 to cause fluid at a consistent high pressure to be delivered into the jetting dispenser body 12 and then jetted as droplets out of the jetting dispensing system 10 for flight towards the substrate 24. It will be appreciated that the pressure sensor is not limited to the particular diaphragm-type sensor described in detail herein, but may also be embodied in the form of, for example, a resistive transducer, a direct piezo load cell, or any other type of sensor that is capable of measuring a fluid pressure and, preferably, converting said fluid pressure into an electrical signal.

Having described the general function of the pressure sensor and its operative connection with the controller 18, details of one possible construction will now be described. With reference to FIGS. 3 and 4, the fluid inlet 32 and the passageway 42 connecting the fluid connection interface 30 with the fluid chamber 34 include a number of interconnected segments of various lengths and orientations. Shortly after the fluid material passes through the fluid connection interface 30, the fluid material flowing in the fluid inlet 32 interacts with the diaphragm 124. The diaphragm 124 includes a peripheral ring that is securely anchored and a thin, semi-rigid membrane surrounded about its perimeter by the peripheral ring. The front side of the membrane of the diaphragm 124 is wetted by the flowing fluid material in the fluid inlet 32 and the back side of the membrane of the diaphragm 124 is not wetted. The differential fluid pressure across the opposite sides of the membrane of diaphragm 124 causes the membrane to deflect in proportion to the amount of fluid pressure applied by the fluid material to the diaphragm 124. Increasing fluid pressures in the fluid inlet 32 may cause greater amounts of deflection. In the illustrated embodiment, the diaphragm 124 is sandwiched between the first section 40 of the jetting dispenser body 12 and a diaphragm locking member 128 connected with the first section 40. The diaphragm locking member 128 may be elongated as shown to partially fit within a bore that carries the rod 126 in the actuator body 74, such that the rod 126 will contact the diaphragm 124 by extending through the diaphragm locking member 128 when the fluid module is engaged with the actuator body 74.

As briefly described above, the rod 126 extends from the backside of the membrane of the diaphragm 124 to contact the load cell (not shown). The deformation of the membrane of the diaphragm 124 varies in proportion to the fluid pressure. As the fluid pressure changes, the diaphragm 124 communicates a force to the load cell via the intervening rod 126 that is proportional to the fluid pressure. The load cell communicates the pressure measurement readings to the controller 18 for the jetting dispensing system 10. In this manner, the diaphragm 124 and load cell cooperate to form a pressure sensor that measures and assesses fluid pressure in the fluid inlet 32 for use in controlling the operation of the jetting dispensing system 10 (and specifically of the progressive cavity pump 14). If necessary, the operation or actuation of the progressive cavity pump 14 can be adjusted by the controller 18 based on the signals from the load cell to ensure that the consistent incoming fluid pressure is maintained within the fluid chamber 34, which is caused by refilling the fluid chamber 34 with an equivalent volume of fluid that is removed in the jetting dispensing cycles.

Alternatively, some embodiments of the jetting dispensing system 10 may operate the controller 18 based on different types of feedback, which may omit the need for the pressure sensor in some examples. In one particular embodiment, the controller 18 would be operatively connected to the valve actuator 20 and would receive signals indicating when the valve actuator 20 causes a jetting dispensing cycle to discharge a droplet of the fluid from the jetting dispensing system 10. For each actuation of the valve actuator 20 or jetting dispensing cycle, the progressive cavity pump 14 is operated to move a set incremental amount for each jetting dispensing cycle, the set incremental amount being configured to supply an equivalent volume of the fluid into the fluid chamber 34 that was removed by dispensing a droplet as caused by actuation of the valve actuator 20. In the example of the progressive cavity pump 14 described further below, the movement by a set incremental amount may include rotation of a central drive member 142 through a certain angle of rotation for each jetting dispensing cycle. This control arrangement is more of an open loop control in this alternative embodiment use of the controller 18. Regardless of the particular type of control enabled by the jetting dispensing system 10, the progressive cavity pump 14 is controlled to refill the fluid chamber 34 with fluid (e.g., high pressure fluid) at the same flow rate at which the fluid is being removed by the jetting or dispensing process.

As shown in FIGS. 2 and 2A, the fluid connection interface 30 of the jetting dispenser body 12 is fed fluid by connection with the progressive cavity pump 14. An exemplary embodiment of the progressive cavity pump 14 is now described in further detail below. As a preliminary matter, the progressive cavity pump 14 is fed at an inlet thereof by any known type of fluid source or supply, one example of which is shown as a pressurized syringe 132 in FIGS. 2 and 2A. This syringe 132 of the fluid source 16 shown in these Figures may be configured to be similar to the syringes which were used to directly feed into jetting dispensing systems of conventional designs. For example, the syringe 132 may use pressurized air to direct the fluid material to flow toward the inlet of the progressive cavity pump 14, which eventually feeds to the fluid chamber 34 of the fluid module. The pressure supplied to the head space above the fluid material contained in the syringe 132, may range from 0.5 barg (approx. 7.25 psig) to 4 barg (approx. 58.02 psig). The specific pressure of the fluid delivered into the inlet of the progressive cavity pump 14 is not critical because the progressive cavity pump 14 may provide, if required by the particular dispensing application, the sufficiently high pressurization to the fluid that may afford some of the advantageous benefits of the current disclosure. Different types of fluid sources 16 may be used to feed fluid into the progressive cavity pump 14 in other embodiments consistent with this disclosure.

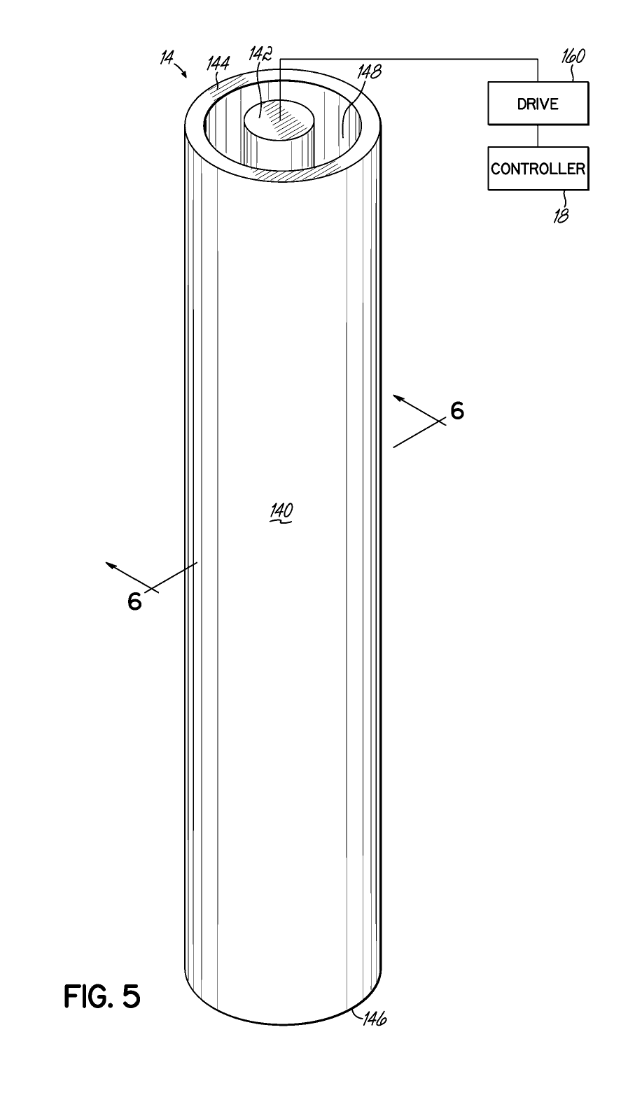

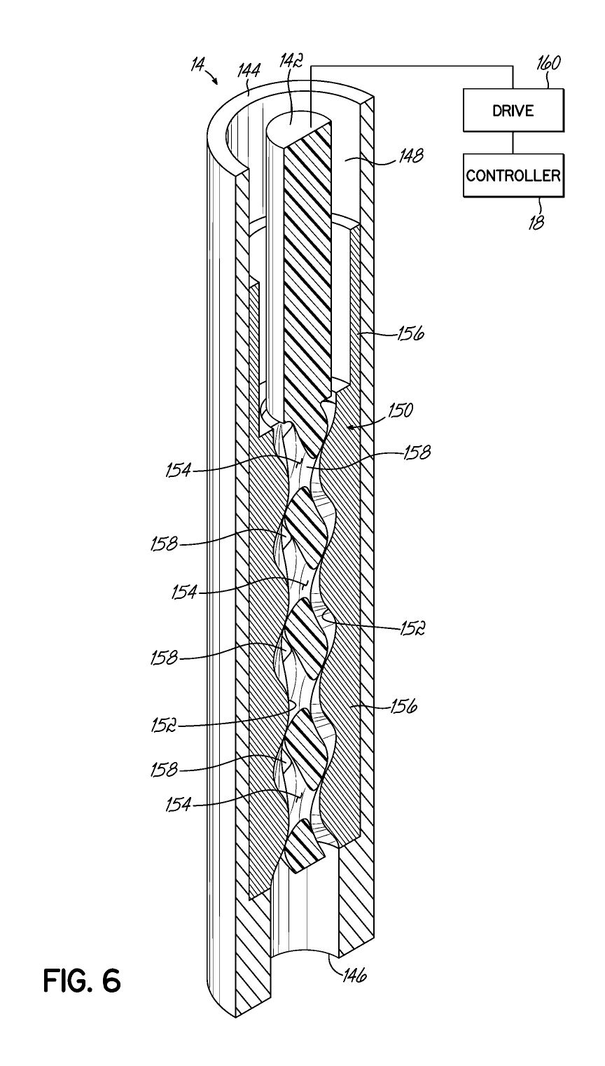

With reference to FIGS. 5 and 6, the progressive cavity pump 14 used with the exemplary embodiment of the jetting dispensing system 10 is shown in further detail. The progressive cavity pump 14 and the fluid source 16 collectively define a fluid supply assembly. The progressive cavity pump 14 includes a pump housing 140 and a central drive member 142, each of which can be seen at an inlet end 144 of the pump housing 140 in FIG. 5. As better shown in FIG. 6, the pump housing 140 extends along an elongate length from the inlet end 144 to an outlet end 146 opposite the inlet end 144. Although the inlet end 144 is shown open adjacent to the end of the central drive member 142 in FIG. 5, the inlet may be defined by a radially extending passage projecting outwardly from a sidewall of the pump housing 140 in other embodiments as shown in the layout of FIGS. 2 and 2A. The pump housing 140 defines a conduit 148 for fluid flow along this elongate length, the conduit 148 being partially filled with the central drive member 142. Along at least a pumping portion 150 of this conduit 148, the pump housing 140 defines a contoured periphery 152 defining the outermost extent of the conduit 148. This contoured periphery 152 in the exemplary embodiment is formed as multiple undulations or a rolling contour when seen in cross section, and this shape is configured to engage with the corresponding contoured shape of the central drive member 142 to produce separate fluid cavities.

The central drive member 142 typically defines a solid helical shape defining a twin helix shape along an outer surface 154 thereof. Although the elements may be formed from different types of materials, in the exemplary embodiment the pump housing 140 includes a rubber or some other elastomeric sleeve 156 which defines the pumping portion 150 and the contoured periphery 152, while the central drive member 142 is formed from a rigid material like steel. As the central drive member 142 rotates, the helix-shape rotates against the rubber material of the sleeve 156 to produce a series of discrete separated cavities 158 that are sealed from one another. The cavities 158 are generally helix shaped as well, with tapering ends such that the beginning of one cavity 158 overlaps the end of another cavity 158 on an opposite side of the rotor defined by the central drive member 142. To this end, as one of the discrete cavities 158 reaches the outlet end 146 and begins to taper down, delivering less flow to the outlet end 146, the next cavity also begins to open to the outlet end 146, thereby keeping the overall flow volume and pressure generally consistent while the central drive member 142 continues to rotate. To this end, there is no “pump wink” effect or refilling cycle that can periodically and adversely affect the pressure delivered by the progressive cavity pump 14. The cavities 158 are generally all the same size and shape, and thus contain a fixed quantity of fluid volume that does not change as the cavities 158 move along the conduit 148.

The lack of an open flow path through the elongate length of the conduit 148 means that the volumetric flow rate delivered by the progressive cavity pump 14 is directly proportional to the rotation rate of the central drive member 142. Accordingly, this is the reason the specific inlet pressure delivered by the fluid source 16 does not matter, as the progressive cavity pump 14 produces the set pressure and flow rate at the outlet based solely on the rotational speed of the central drive member 142 (and the corresponding longitudinal movement speed of the cavities 158). Each of the cavities 158 effectively rotates like a helix around the central drive member 142 during this rotation of the central drive member 142, so there are very low or even zero levels of shearing forces applied to the fluid as it moves along the length of the conduit 148. Consequently, any fluid particle damage that would be caused in other types of pumps where shearing action on the fluid is used would be avoided in this embodiment thanks to the operation of the progressive cavity pump 14. In this regard, the progressive cavity pump 14 provides a more gentle process of pumping the fluid to the jetting dispenser body 12 than other conventional pump designs. Additionally, the displacement forces that move the cavities 158 around the central drive member 142 and along the length of the conduit 148 are applied along an entirety of the length of the pumping portion 150. To this end, the progressive cavity pump 14 functions like a positive displacement pump in displacing a fixed volume of material for each fixed rotation or movement of the central drive member 142.

In some designs of the progressive cavity pump 14, the motions of the outer surface 154 of the central drive member 142 is a rolling motion around and against the contoured periphery 152 similar to the motion of smaller gears in a planetary gear system. The central drive member 142 can therefore be mounted within the progressive cavity pump 14 to both move around the conduit 148 and rotate at the same time, an eccentric movement in the form of a hypocycloid. The central drive member 142 may include one or more universal joints and other known bearing members to allow for this movement within the pump housing 140. Other designs and specific movement patterns of the central drive member 142 are possible in other embodiments of the progressive cavity pump 14, but regardless of the method of movement and mounting chosen, the central drive member 142 always results in discrete separated cavities of fluid propagating along the length of the conduit 148 whenever the central drive member 142 is rotating.

The progressive cavity pump 14 is operatively coupled to the controller 18 as described briefly above. More particularly, the progressive cavity pump 14 includes some form of a drive 160 (motor, etc.) connected to the central drive member 142 and actuated to rotate the central drive member 142 at controllable varied speeds. The controller 18 sends operational signals to the drive 160 to operate the progressive cavity pump with a constant rotation speed of the central drive member 142 during normal operation of the jetting dispensing system 10. If the pressure sensor (e.g., the pressure sensor defined by the diaphragm 124, the rod 126, and the load sensor) detects that the fluid pressure at the jetting dispenser body 12 is not at a desired value, the speed of rotation of the central drive member 142 is adjusted accordingly by the controller 18 to correct for the deficiency in pressure.

In sum, the controller 18 operates the progressive cavity pump 14 to provide a consistent incoming fluid pressure at the fluid inlet 32 and the fluid chamber 34, this pressure being capable of being much higher than conventional syringe-based pressure feeds. For example, the consistent incoming fluid pressure delivered by the progressive cavity pump 14 may be greater than 10 barg (approx. 145.04 psig), while syringe-based feed assemblies cap out at a maximum of about 6 to 7 barg (approx. 87.02 psig to approx. 101.52 psig). The higher potential pressure output of a progressive cavity pump 14 is also a result of applying the displacement forces to the cavities 158 along the entire length of the conduit 148 at the pumping portion 150. This higher pressure can go to 30 barg (approx. 435.11 psig) or even greater, and that may provide additional benefits when jetting fluid from the jetting dispenser body 12. To this end, the higher consistent pressure within the fluid chamber 34 enables each jetted droplet to define a consistent volume of fluid when the jetting dispensing cycle is identical (e.g., when the piezoelectric stacks 92a, 92b are actuated for the same amount of time on each jetting dispensing cycle). This generation of same size droplets is achieved using the progressive cavity pump 14 feed regardless of viscosity variations in the fluid as well, as evidenced by lab testing performed by Applicant using this jetting dispensing system 10. Furthermore, a greater amount of substantive-volume droplets can be produced by a rapid cycling the jetting dispensing system 10, including on the order of up to 500 droplets per second in some embodiments or up to 3000 droplets per second in other embodiments, particularly those actuated by a piezoelectric actuator. Hypothetically, this increased frequency of the jetting dispensing cycles could also be successfully achieved with lower valve element speeds, which would limit wear damage over time and reduce the need to replace or provide maintenance to the moving parts of the jetting dispensing system 10.

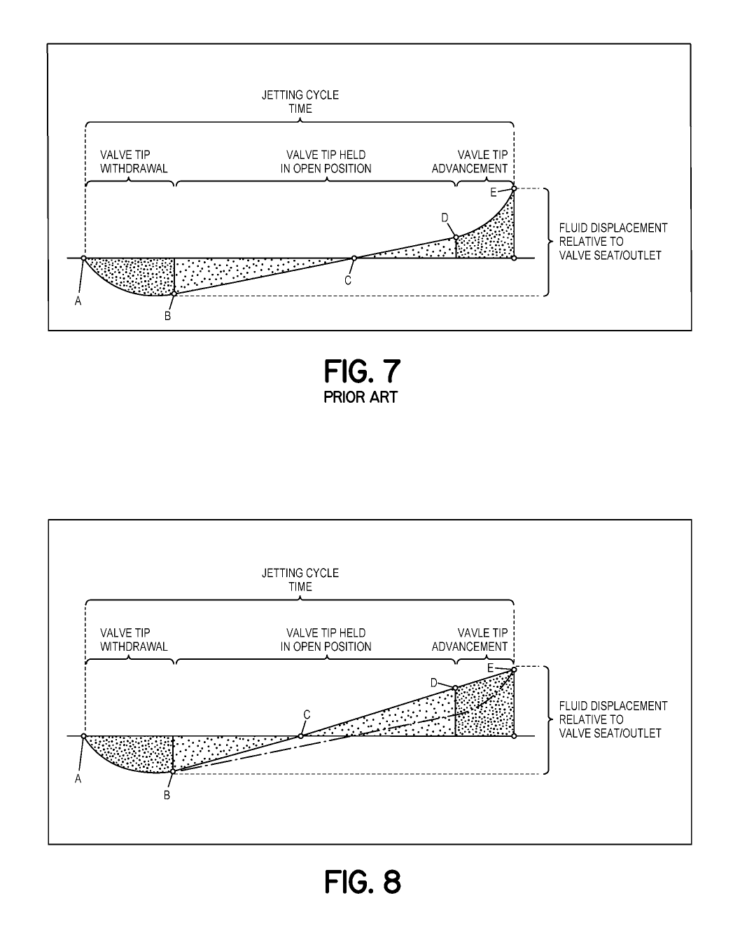

Another advantage of the use of the progressive cavity pump 14 in the jetting dispensing system 10 of this embodiment is revealed in FIG. 8, which is a schematic graphical plot of fluid displacement (relative to the dispensing outlet 36 of the jetting dispensing system 10) over time, specifically over a single jetting dispensing cycle. This is a similar jetting dispensing cycle as shown in FIG. 7 for conventional jetting designs, for the purposes of comparison. However, as described below, the fluid displacement and velocity over time is much more uniform in the jetting dispensing system 10 of this disclosure.

Thus, points A and E on the plot are times where the valve element 56 is engaged with the valve seat 52, e.g., immediately before the valve element 56 is withdrawn by moving the valve element 56 upwardly off the valve seat 52, and immediately after the valve element 56 has been advanced back into engagement with the valve seat 52. The fluid experiences a temporary snuff-back effect and moves away from the valve seat 52 back into the fluid chamber 34 as a result of the valve element 56 withdrawal between points A and B, which is illustrated by the fluid displacement line moving below the horizontal zero axis. Between points B and D, the valve element 56 is temporarily held in the open position by the valve actuator 20, and the pressurization applied by the progressive cavity pump 14 causes fluid to flow back to the valve seat 52 and through the valve seat 52, which starts extrusion of a droplet from the jetting dispenser body 12 at point C. The slope of the fluid displacement line is generally constant over this time window (and greater than the slope in the FIG. 7 view, as a result of the higher applied pressure of the fluid within the fluid chamber 34). The valve element 56 is advanced back into engagement with the valve seat 52 over the time period from points D to E, but unlike the conventional design, the slope or fluid velocity continues to stay at the same generally constant value as it was during the points B to D. To clarify these differences, the plot line from FIG. 7 is repeated in phantom on FIG. 8 so that these differences in the fluid displacement over time are more clear.

The substantially similar fluid velocity is therefore maintained when using the jetting dispensing system 10 of the current embodiment both at the beginning of fluid discharge from the jetting dispenser body 12 and at the end of fluid discharge for any droplet. This similar velocity avoids having one portion of the droplet moving faster than another portion of the droplet during flight, and thus, no rotational tumble or blossoming movements of the droplet are typically encountered during flight to the substrate 24. That makes the droplets 22 dispensed by the system 10 more predictable and controllable, which is desired in certain applications where the application of fluid must be precise. For example, these fields can include camera module assembly, where an epoxy adhesive must be jetted into a 90 micrometer slot, or RF (radio frequency) shield attachment, where a highly viscous solder paste must be jetted into a 300 micrometer bead. The lack of sensitivity to fluid viscosity allows the jetting dispensing system 10 to provide these functional benefits even when working with solder paste, and even when needing to jet droplets into smaller geometries such as in the camera module assembly field, or in the chip underfill field.

Generally speaking, the jetting dispensing system 10 may be installed in a machine or system (not shown) for intermittently jetting amounts of a fluid material onto a substrate 24 and may be moved relative to the substrate 24 as the amounts of fluid material are jetted. The jetting dispensing system 10 may be operated such that a succession of jetted amounts or droplets 22 of the fluid material are deposited on the substrate 24 as a line of spaced-apart material dots (which may coalesce into a bead). During such a continuous series of jetting dispensing cycles also referred to as an “on the fly” operation, the progressive cavity pump 14 operates continuously to maintain the consistent incoming fluid pressure at all times within the fluid chamber 34. The substrate 24 targeted by the jetting dispensing system 10 may support various surface mounted electronic components, which necessitates non-contact jetting of the minute amounts of fluid material rapidly and with accurate placement to deposit fluid material at targeted locations on the substrate 24.

As detailed above, the jetting dispensing system 10 may enable such accurate placement thanks, at least in part, to the consistent incoming fluid pressure provided in the fluid module by the progressive cavity pump 14. To this end, every time the jetting dispensing system 10 performs a jetting dispensing cycle, the same amount of fluid is forced out by the consistent pressure to make the droplet 22, and the progressive cavity pump 14 reliably refills the same amount back into the fluid chamber 34 every cycle as well. To this end, the progressive cavity pump 14 operates with open loop or closed loop control to supply the same amount of fluid flow as is being removed from the fluid chamber 34 to maintain the generally high pressure therein. These benefits are achieved regardless of the viscosity and compressibility of the fluid being dispensed, making this a useful system for jetting high viscosity fluids such as solder pastes. Additionally, the fluid module is accessible for easy removal without tools from the bottom of the jetting dispensing system 10. The jetting dispensing system 10 provides more consistent volume and predictable droplets 22 of various types of fluids, thereby addressing some of the shortcomings with conventional jetting devices.

While the present disclosure has been illustrated by a description of exemplary embodiments and while these embodiments have been described in some detail, it is not the intention of the Applicant to restrict or in any way limit the scope of the appended claims to such detail. Additional advantages and modifications will readily appear to those skilled in the art. For example, although a piezoelectric actuation is described above for the valve actuator 20, it will be appreciated that the valve element 56 can be operated by other known types of actuators, including electro-pneumatic drives moving the drive pin 58 with pressurized air (acting on a piston or the like), mechanical motor-based drives, and other known actuators. The various features of the disclosure may be used alone or in any combination depending on the needs and preferences of the user. This has been a description of the disclosure, along with the preferred methods of practicing it as currently known. However, the disclosure itself should only be defined by the appended claims.

What is claimed is:

1. A jetting system for dispensing droplets of fluid onto a substrate, the jetting system comprising:
a jetting dispenser body including a fluid chamber, a fluid inlet and a dispensing outlet communicating with the fluid chamber, and a valve seat defined in the fluid chamber between the fluid inlet and the dispensing outlet;
a valve element extending into the fluid chamber;
a valve actuator operatively coupled with the valve element for moving the valve element into and out of engagement with the valve seat to thereby define jetting dispensing cycles for forcing droplets out of the dispensing outlet; and
a fluid supply assembly coupled with the jetting dispenser body and including a progressive cavity pump that feeds fluid from a fluid source to the fluid inlet of the jetting dispenser body.

2. The jetting system of claim 1, the progressive cavity pump further comprising:
a pump housing defining a conduit along an elongate length, the conduit having a contoured periphery; and
a central drive member extending through the conduit to define a plurality of separated cavities defined between the central drive member and the contoured periphery, the central drive member rotating to propagate the plurality of separated cavities along the elongate length of the conduit and towards the fluid inlet such that displacement forces on the fluid in each of the plurality of separated cavities are applied along an entirety of the elongate length of the conduit.

3. The jetting system of claim 2, the progressive cavity pump operating continuously during a continuous series of the jetting dispensing cycles at the jetting system to maintain an incoming fluid pressure at all times within the fluid chamber of the jetting dispenser body.

4. The jetting system of claim 3, the valve actuator controlling the jetting dispensing cycles such that the incoming fluid pressure in the fluid chamber results in droplets having a consistent volume for each jetting dispensing cycle.

5. The jetting system of claim 4, wherein the progressive cavity pump operates to refill the fluid chamber with an equivalent volume of the fluid that is removed during each of the jetting dispensing cycles.

6. The jetting system of claim 2, further comprising:
a controller operatively coupled to the valve actuator and the progressive cavity pump, the controller actuating the progressive cavity pump to rotate the central drive member a set incremental amount for each actuation of the valve actuator.

7. The jetting system of claim 1, further comprising:
a pressure sensor positioned in a flow path between the fluid inlet and the fluid chamber and configured to measure the incoming fluid pressure in the flow path; and
a controller operatively coupled to the progressive cavity pump, the controller adjusting actuation of the progressive cavity pump based on feedback from the pressure sensor to maintain an incoming fluid pressure.

8. The jetting system of claim 7, wherein the pressure sensor comprises:
a diaphragm located at the jetting dispenser body in communication with the flow path between the fluid inlet and the fluid chamber, the diaphragm thereby receiving the fluid pressure in the flow path; and
a load sensor coupled with the diaphragm and configured to measure a force based upon the fluid pressure transferred from the diaphragm, thereby to confirm that the fluid pressure remains constant.

9. The jetting system of claim 1, further comprising:
a controller operatively coupled to the progressive cavity pump, the controller actuating the progressive cavity pump to supply fluid to the fluid inlet with an incoming fluid pressure of at least 7 barg.

10. The jetting system of claim 9, the controller also operatively coupled to the valve actuator and operating the valve actuator such that the valve element performs up to 500 jetting dispensing cycles per second.

11. The jetting system of claim 9, the valve actuator including a piezoelectric element operatively coupled to the valve element to generate reciprocal movements of the valve element.

12. The jetting system of claim 11, the controller also operatively coupled to the valve actuator and operating the valve actuator such that the valve element performs up to 3000 jetting dispensing cycles per second.

13. A method for dispensing a plurality of droplets of fluid onto a substrate using a jetting system including a jetting dispenser body, a valve actuator, and a fluid supply assembly with a progressive cavity pump, the method comprising:
pumping fluid with the progressive cavity pump from a fluid source to a fluid inlet of the jetting dispenser body;
flowing the fluid from the fluid inlet into a fluid chamber of the jetting dispenser body, the fluid chamber also communicating with a dispensing outlet and defining a valve seat between the fluid inlet and the dispensing outlet; and
operating a valve element extending into the fluid chamber with the valve actuator to move away from and towards engagement with the valve seat, thereby defining jetting dispensing cycles for forcing droplets out of the dispensing outlet for flight towards and onto the substrate.

14. The method of claim 13, wherein the fluid dispensed by the jetting system varies in viscosity, and the method further comprises:
discharging droplets having a consistent volume for each jetting dispensing cycle, regardless of changes in viscosity of the fluid.

15. The method of claim 14, wherein pumping fluid with the progressive cavity pump further comprises:
refilling the fluid chamber with an equivalent volume of the fluid that is removed during each of the jetting dispensing cycles.

16. The method of claim 13, wherein operating the valve element causes movement of the fluid relative to the valve seat defining a fluid velocity profile over time, the fluid velocity profile being generally constant such that for any droplet discharged through the dispensing outlet, the velocity of fluid that first exits the dispensing outlet is proximate to the velocity of fluid that last exits the dispensing outlet.

17. The method of claim 16, further comprising:
controlling a velocity of the fluid exiting the dispensing outlet over time so as to avoid blossoming or rotational tumbling movements of the droplet during flight to the substrate.

18. The method of claim 13, wherein pumping fluid with the progressive cavity pump further comprises:
maintaining the fluid into the jetting dispenser body at an incoming fluid pressure set by the progressive cavity pump.

19. The method of claim 18, wherein operating the valve element includes closing the valve element into engagement with the valve seat, which results in a pressure spike within the fluid chamber, and the method further comprises:
setting the incoming fluid pressure with the progressive cavity pump to be sufficiently high to minimize the pressure spike within the fluid chamber, thereby minimizing damage done to particles of fluid that would be caused by the pressure spike.

20. The method of claim 19, wherein setting the incoming fluid pressure with the progressive cavity pump further comprises:
operating the progressive cavity pump to produce the incoming fluid pressure to be at least 7 barg.

21. The method of claim 13, wherein operating the valve element further comprises:
actuating the valve element with the valve actuator to perform up to 500 dispensing cycles per second.

22. The method of claim 13, the valve actuator including a piezoelectric element operatively coupled to the valve element to operate the valve element.

23. The method of claim 22, wherein operating the valve element further comprises:
actuating the valve element with the valve actuator to perform up to 3000 dispensing cycles per second.

24. The method of claim 13, wherein the progressive cavity pump includes a pump housing defining a conduit along an elongate length and a central drive member extending through the conduit to define a plurality of separated cavities defined between the central drive member and the pump housing, and pumping fluid with the progressive cavity pump further comprises:
rotating the central drive member to propagate the plurality of separated cavities and the fluid therein along the elongate length of the conduit and towards the fluid inlet, thereby applying displacement force to the fluid along an entirety of the elongate length.

25. The method of claim 24, wherein pumping fluid with the progressive cavity pump further comprises:
operating the central drive member to rotate continuously during a continuous series of the jetting dispensing cycles at the jetting system, so as to maintain an incoming fluid pressure at all times within the fluid chamber of the jetting dispenser body.

26. The method of claim 24, wherein pumping fluid with the progressive cavity pump further comprises:
operating the central drive member to rotate a set incremental amount for each actuation of the valve element with the valve actuator.

27. The method of claim 13, further comprising:
sensing a fluid pressure adjacent at least one of the fluid inlet and the fluid chamber of the jetting dispenser body with a diaphragm and load sensor, thereby to confirm that an incoming fluid pressure remains constant; and
adjusting actuations of the progressive cavity pump based on feedback from the load sensor to maintain the incoming fluid pressure within the fluid chamber.

28. The method of claim 13, wherein the pumping of fluid into the jetting dispenser body with the progressive cavity pump and the jetting dispensing cycles collectively result in discharge of droplets having a consistent volume for each jetting dispensing cycle.
